(19) United States
(12) Patent Application Publication
(10) Pub. No.: US 2015/0268449 A1
(43) Pub. Date: Sep. 24, 2015

(54) SINGLE FOCAL LENGTH IMAGING OPTICAL SYSTEM, LENS BARREL, INTERCHANGEABLE LENS APPARATUS AND CAMERA SYSTEM

(71) Applicant: Panasonic Intellectual Property Management Co., Ltd., Osaka (JP)

(72) Inventors: Yoshiaki KURIOKA, Osaka (JP); Takehiro NISHIOKA, Nara (JP)

(21) Appl. No.: 14/631,100

(22) Filed: Feb. 25, 2015

(30) Foreign Application Priority Data
Mar. 20, 2014 (JP) 2014-057474

(51) Int. Cl. G02B 13/00; H04N 5/225; G02B 7/09; G03B 13/32; G02B 9/64

(52) U.S. Cl. CPC G02B 13/0015; G03B 13/32; G02B 9/64; G02B 13/001; G02B 7/09; H04N 5/2254

(57) ABSTRACT

A single focal length imaging optical system, in order from an object side to an image side, comprising: a front unit composed of a plurality of lens elements; an aperture diaphragm; and a rear unit composed of a plurality of lens elements, wherein the front unit, in order from the object side to the image side, includes a lens element having negative optical power, a lens element having negative optical power, and a lens element having positive optical power, and includes a lens element having positive optical power and placed closest to the image side, and the rear unit includes a focusing lens unit which is composed of at least one lens element and moves along an optical axis in focusing from an infinity in-focus condition to a close-object in-focus condition, and a lens element having negative optical power and placed closest to the image side.

### CROSS-REFERENCE TO RELATED APPLICATION

This application is based on application No. 2014-057474 filed in Japan on Mar. 20, 2014, the contents of which are hereby incorporated by reference.

### BACKGROUND

1. Field

The present disclosure relates to single focal length imaging optical systems, lens barrels, interchangeable lens apparatuses and camera systems.

2. Description of the Related Art

For example, Japanese Laid-Open Patent Publication No. 2012-123122 discloses a lens system having a three-unit configuration of positive, positive and negative, and adopting a floating system in which, in focusing, a first lens unit and a second lens unit are moved at different rates along an optical axis.

Besides Japanese Laid-Open Patent Publication No. 2012-123122, there are Japanese Laid-Open Patent Publications Nos. 2013-186458, 2012-255842, 2013-195558, 2010-181518, 2013-037339, and 08-086964 which are related to lens systems each having a three-unit configuration.

### SUMMARY

The present disclosure provides a single focal length imaging optical system which is bright because having a small F-number, is compact, and suppresses occurrences of various aberrations. Further, the present disclosure provides a lens barrel, an interchangeable lens apparatus, and a camera system each including the single focal length imaging optical system.

The novel concepts disclosed herein were achieved in order to solve the foregoing problems in the related art, and herein is disclosed:

a single focal length imaging optical system, in order from an object side to an image side, comprising: a front unit composed of a plurality of lens elements; an aperture diaphragm; and a rear unit composed of a plurality of lens elements, wherein

the front unit, in order from the object side to the image side, includes a lens element having negative optical power, a lens element having negative optical power, and a lens element having positive optical power, and includes a lens element having positive optical power and placed closest to the image side, and

the rear unit includes a focusing lens unit which is composed of at least one lens element and moves along an optical axis in focusing from an infinity in-focus condition to a close-object in-focus condition, and a lens element having negative optical power and placed closest to the image side.

The novel concepts disclosed herein were achieved in order to solve the foregoing problems in the related art, and herein is disclosed:

a lens barrel configured to hold a single focal length imaging optical system, wherein

the single focal length imaging optical system, in order from an object side to an image side, comprising: a front unit composed of a plurality of lens elements; an aperture diaphragm; and a rear unit composed of a plurality of lens elements, wherein

the front unit, in order from the object side to the image side, includes a lens element having negative optical power, a lens element having negative optical power, and a lens element having positive optical power, and includes a lens element having positive optical power and placed closest to the image side, and

the rear unit includes a focusing lens unit which is composed of at least one lens element and moves along an optical axis in focusing from an infinity in-focus condition to a close-object in-focus condition, and a lens element having negative optical power and placed closest to the image side.

The novel concepts disclosed herein were achieved in order to solve the foregoing problems in the related art, and herein is disclosed:

an interchangeable lens apparatus comprising:

a single focal length imaging optical system; and

a lens mount section which is connectable to a camera body including an image sensor for receiving an optical image formed by the single focal length imaging optical system and converting the optical image into an electric image signal, wherein

the single focal length imaging optical system, in order from an object side to an image side, comprising: a front unit composed of a plurality of lens elements; an aperture diaphragm; and a rear unit composed of a plurality of lens elements, wherein

the front unit, in order from the object side to the image side, includes a lens element having negative optical power, a lens element having negative optical power, and a lens element having positive optical power, and includes a lens element having positive optical power and placed closest to the image side, and the rear unit includes a focusing lens unit which is composed of at least one lens element and moves along an optical axis in focusing from an infinity in-focus condition to a close-object in-focus condition, and a lens element having negative optical power and placed closest to the image side.

The novel concepts disclosed herein were achieved in order to solve the foregoing problems in the related art, and herein is disclosed:

a camera system comprising:

an interchangeable lens apparatus including a single focal length imaging optical system; and

a camera body which is detachably connected to the interchangeable lens apparatus via a camera mount section, and includes an image sensor for receiving an optical image formed by the single focal length imaging optical system and converting the optical image into an electric image signal, wherein

the single focal length imaging optical system, in order from an object side to an image side, comprising: a front unit composed of a plurality of lens elements; an aperture diaphragm; and a rear unit composed of a plurality of lens elements, wherein

the front unit, in order from the object side to the image side, includes a lens element having negative optical power, a lens element having negative optical power, and a lens element having positive optical power, and includes a lens element having positive optical power and placed closest to the image side, and

the rear unit includes a focusing lens unit which is composed of at least one lens element and moves along an optical axis in focusing from an infinity in-focus condition to a close-object in-focus condition, and a lens element having negative optical power and placed closest to the image side.

The single focal length imaging optical system according to the present disclosure is an optical system which is bright because having a small F-number, is compact, and suppresses occurrences of various aberrations.

### BRIEF DESCRIPTION OF THE DRAWINGS

This and other objects and features of the present disclosure will become clear from the following description, taken in conjunction with the exemplary embodiments with reference to the accompanied drawings in which:

FIG. 1 is a lens arrangement diagram showing an infinity in-focus condition of a single focal length imaging optical system according to Embodiment 1 (Numerical Example 1);

FIG. 2 is a longitudinal aberration diagram of the infinity in-focus condition of the single focal length imaging optical system according to Numerical Example 1;

FIG. 3 is a lens arrangement diagram showing an infinity in-focus condition of a single focal length imaging optical system according to Embodiment 2 (Numerical Example 2);

FIG. 4 is a longitudinal aberration diagram of the infinity in-focus condition of the single focal length imaging optical system according to Numerical Example 2;

FIG. 5 is a lens arrangement diagram showing an infinity in-focus condition of a single focal length imaging optical system according to Embodiment 3 (Numerical Example 3);

FIG. 6 is a longitudinal aberration diagram of the infinity in-focus condition of the single focal length imaging optical system according to Numerical Example 3;

FIG. 7 is a lens arrangement diagram showing an infinity in-focus condition of a single focal length imaging optical system according to Embodiment 4 (Numerical Example 4);

FIG. 8 is a longitudinal aberration diagram of the infinity in-focus condition of the single focal length imaging optical system according to Numerical Example 4;

FIG. 9 is a lens arrangement diagram showing an infinity in-focus condition of a single focal length imaging optical system according to Embodiment 5 (Numerical Example 5);

FIG. 10 is a longitudinal aberration diagram of the infinity in-focus condition of the single focal length imaging optical system according to Numerical Example 5; and

FIG. 11 is a schematic construction diagram of an interchangeable-lens type digital camera system adopting the single focal length imaging optical system according to Embodiment 1.

### DETAILED DESCRIPTION

Hereinafter, embodiments will be described with reference to the drawings as appropriate. However, descriptions more detailed than necessary may be omitted. For example, detailed description of already well known matters or description of substantially identical configurations may be omitted. This is intended to avoid redundancy in the description below, and to facilitate understanding of those skilled in the art.

It should be noted that the applicants provide the attached drawings and the following description so that those skilled in the art can fully understand this disclosure. Therefore, the drawings and description are not intended to limit the subject defined by the claims.

In the present disclosure, a lens unit is composed of at least one lens element, and the optical power, the composite focal length and the like of each lens unit are determined depending on the type, the number, the arrangement and the like of lens elements constituting the lens unit. A unit is composed of at least one lens unit and/or at least two lens elements.

### Embodiments 1 to 5

### Single Focal Length Imaging Optical System

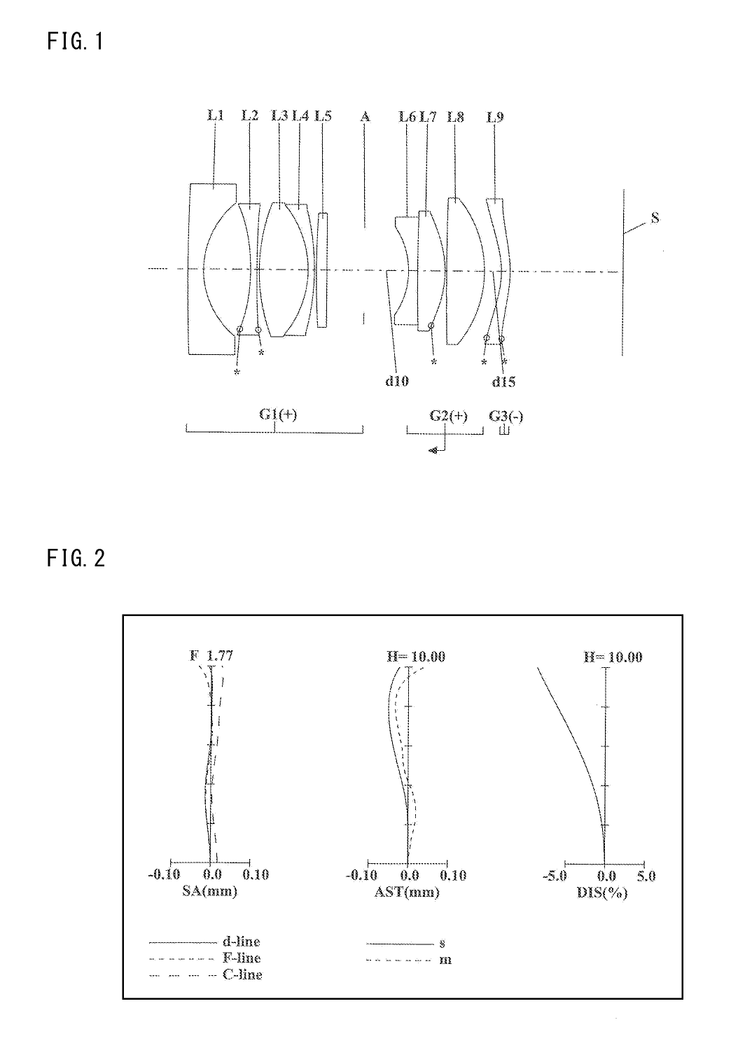

FIGS. 1, 3, 5, 7 and 9 are lens arrangement diagrams of single focal length imaging optical systems according to Embodiments 1 to 5, respectively. Each Fig. shows a single focal length imaging optical system in an infinity in-focus condition.

In each Fig., each arrow parallel to the optical axis, which is imparted to each lens unit, indicates focusing from an infinity in-focus condition to a close-object in-focus condition. That is, the arrow indicates a direction in which a second lens unit G2 described later moves at the time of focusing from an infinity in-focus condition to a close-object in-focus condition.

In each Fig. an asterisk “*” imparted to a particular surface indicates that the surface is aspheric. In each Fig., symbol (+) or (−) imparted to the symbol of each lens unit corresponds to the sign of the optical power of the lens unit. In each Fig., a straight line located on the most right-hand side indicates the position of an image surface S.

### Embodiment 1

FIG. 1 is a lens arrangement diagram showing an infinity in-focus condition of a single focal length imaging optical system according to Embodiment 1.

The single focal length imaging optical system, in order from the object side to the image side, comprises a first lens unit G1 having positive optical power, an aperture diaphragm A, a second lens unit G2 having positive optical power, and a third lens unit G3 having negative optical power. A front unit is composed of the first lens unit G1, and a rear unit is composed of the second lens unit G2 and the third lens unit G3.

The first lens unit G1, in order from the object side to the image side, comprises: a negative meniscus first lens element L1 with the convex surface facing the object side; a bi-concave second lens element L2; a bi-convex third lens element L3; a negative meniscus fourth lens element L4 with the convex surface facing the image side; and a positive meniscus fifth lens element L5 with the convex surface facing the object side. The third lens element L3 and the fourth lens element L4 are cemented with each other.

The second lens unit G2, in order from the object side to the image side, comprises: a bi-concave sixth lens element L6; a bi-convex seventh lens element L7; and a bi-convex eighth lens element L8. The sixth lens element L6 and the seventh lens element L7 are cemented with each other.

The third lens unit G3 comprises solely a negative meniscus ninth lens element L9 with the convex surface facing the image side.

The both surfaces of the second lens element L2, the image side surface of the seventh lens element L7, and the both surfaces of the ninth lens element L9 are aspheric surfaces.

In focusing from an infinity in-focus condition to a close-object in-focus condition, the second lens unit G2 as a focusing lens unit moves to the object side along the optical axis. The first lens unit G1 and the third lens unit G3 are fixed with respect to the image surface S, and do not move in the focusing.

### Embodiment 2

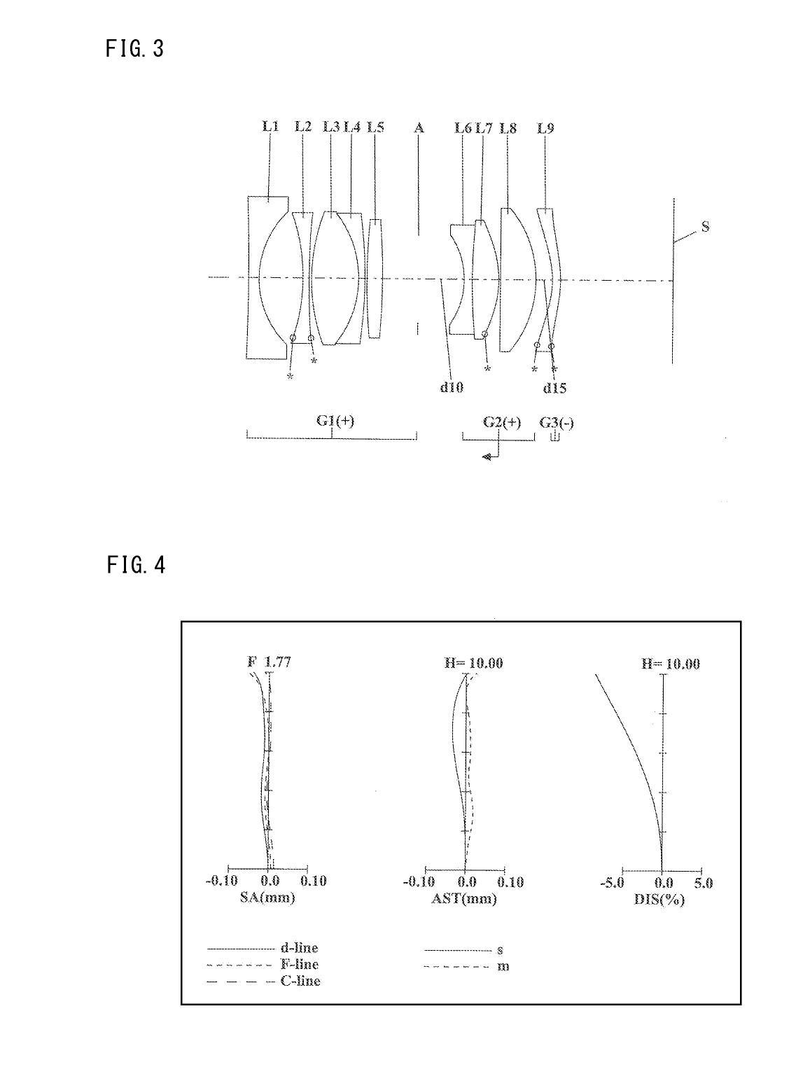

FIG. 3 is a lens arrangement diagram showing an infinity in-focus condition of a single focal length imaging optical system according to Embodiment 2.

The single focal length imaging optical system, in order from the object side to the image side, comprises a first lens unit G1 having positive optical power, an aperture diaphragm A, a second lens unit G2 having positive optical power, and a third lens unit G3 having negative optical power. A front unit is composed of the first lens unit G1, and a rear unit is composed of the second lens unit G2 and the third lens unit G3.

The first lens unit G1, in order from the object side to the image side, comprises: a bi-concave first lens element L1; a bi-concave second lens element L2; a bi-convex third lens element L3; a negative meniscus fourth lens element L4 with the convex surface facing the image side; and a bi-convex fifth lens element L5. The third lens element L3 and the fourth lens element L4 are cemented with each other.

The second lens unit G2, in order from the object side to the image side, comprises: a bi-concave sixth lens element L6; a bi-convex seventh lens element L7; and a bi-convex eighth lens element L8. The sixth lens element L6 and the seventh lens element L7 are cemented with each other.

The third lens unit G3 comprises solely a negative meniscus ninth lens element L9 with the convex surface facing the image side.

The both surfaces of the second lens element L2, the image side surface of the seventh lens element L7, and the both surfaces of the ninth lens element L9 are aspheric surfaces.

In focusing from an infinity in-focus condition to a close-object in-focus condition, the second lens unit G2 as a focusing lens unit moves to the object side along the optical axis. The first lens unit G1 and the third lens unit G3 are fixed with respect to the image surface S, and do not move in the focusing.

### Embodiment 3

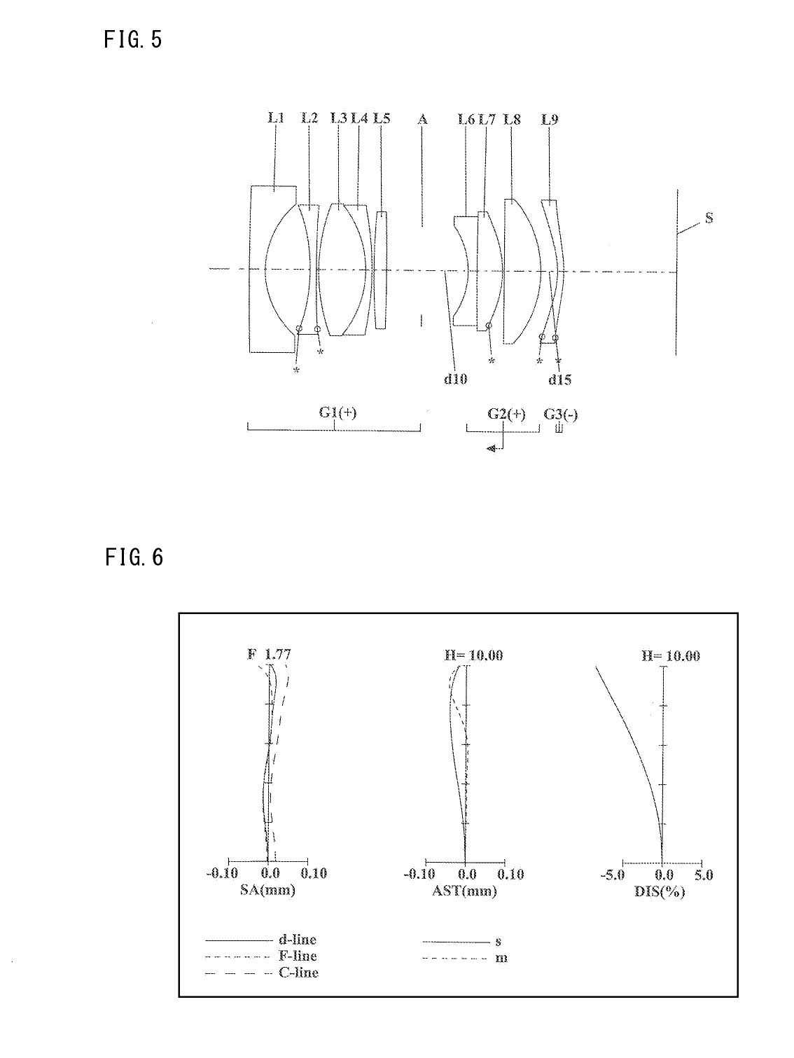

FIG. 5 is a lens arrangement diagram showing an infinity in-focus condition of a single focal length imaging optical system according to Embodiment 3.

The single focal length imaging optical system, in order from the object side to the image side, comprises a first lens unit G1 having positive optical power, an aperture diaphragm A, a second lens unit G2 having positive optical power, and a third lens unit G3 having negative optical power. A front unit is composed of the first lens unit G1, and a rear unit is composed of the second lens unit G2 and the third lens unit G3.

The first lens unit G1, in order from the object side to the image side, comprises: a negative meniscus first lens element L1 with the convex surface facing the object side; a bi-concave second lens element L2; a bi-convex third lens element L3; a negative meniscus fourth lens element L4 with the convex surface facing the image side; and a bi-convex fifth lens element L5. The third lens element L3 and the fourth lens element L4 are cemented with each other.

The second lens unit G2, in order from the object side to the image side, comprises: a bi-concave sixth lens element L6; a bi-convex seventh lens element L7; and a bi-convex eighth lens element L8. The sixth lens element L6 and the seventh lens element L7 are cemented with each other.

The third lens unit G3 comprises solely a negative meniscus ninth lens element L9 with the convex surface facing the image side.

The both surfaces of the second lens element L2, the image side surface of the seventh lens element L7, and the both surfaces of the ninth lens element L9 are aspheric surfaces.

In focusing from an infinity in-focus condition to a close-object in-focus condition, the second lens unit G2 as a focusing lens unit moves to the object side along the optical axis. The first lens unit G1 and the third lens unit G3 are fixed with respect to the image surface S, and do not move in the focusing.

### Embodiment 4

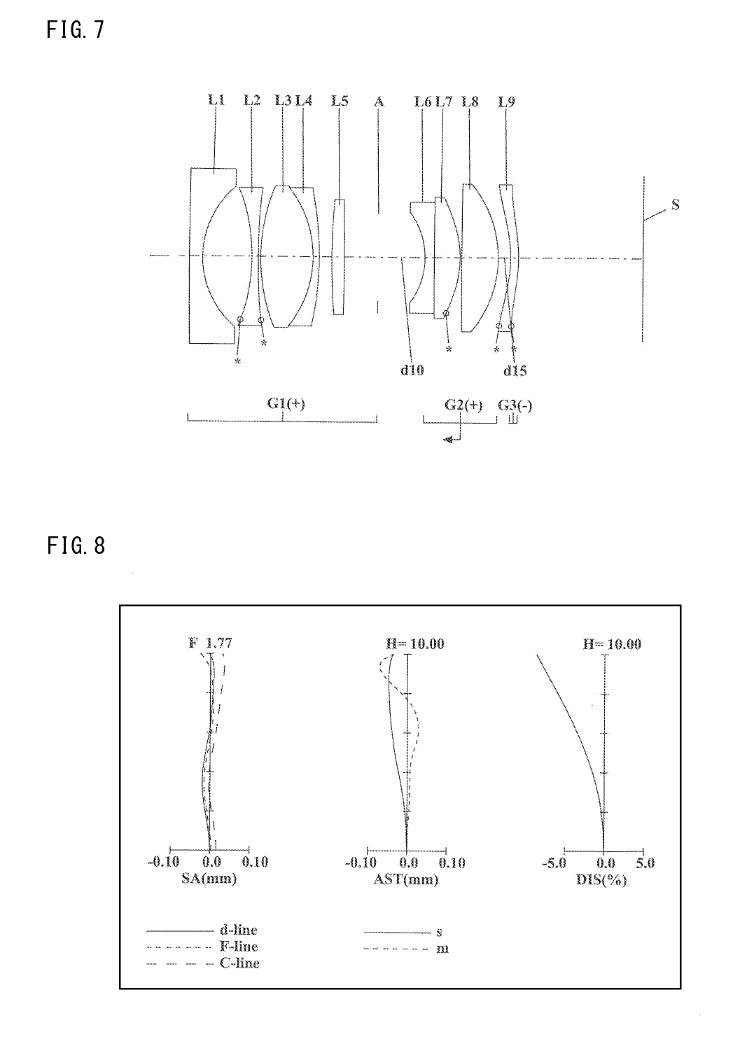

FIG. 7 is a lens arrangement diagram showing an infinity in-focus condition of a single focal length imaging optical system according to Embodiment 4.

The single focal length imaging optical system, in order from the object side to the image side, comprises a first lens unit G1 having positive optical power, an aperture diaphragm A, a second lens unit G2 having positive optical power, and a third lens unit G3 having negative optical power. A front unit is composed of the first lens unit G1, and a rear unit is composed of the second lens unit G2 and the third lens unit G3.

The first lens unit G1, in order from the object side to the image side, comprises: a negative meniscus first lens element L1 with the convex surface facing the object side; a bi-concave second lens element L2; a bi-convex third lens element L3; a negative meniscus fourth lens element L4 with the convex surface facing the image side; and a bi-convex fifth lens element L5. The third lens element L3 and the fourth lens element L4 are cemented with each other.

The second lens unit G2, in order from the object side to the image side, comprises: a bi-concave sixth lens element L6; a bi-convex seventh lens element L7; and a bi-convex eighth lens element L8. The sixth lens element L6 and the seventh lens element L7 are cemented with each other.

The third lens unit G3 comprises solely a negative meniscus ninth lens element L9 with the convex surface facing the image side.

The both surfaces of the second lens element L2, the image side surface of the seventh lens element L7, and the both surfaces of the ninth lens element L9 are aspheric surfaces.

In focusing from an infinity in-focus condition to a close-object in-focus condition, the second lens unit G2 as a focusing lens unit moves to the object side along the optical axis. The first lens unit G1 and the third lens unit G3 are fixed with respect to the image surface S, and do not move in the focusing.

### Embodiment 5

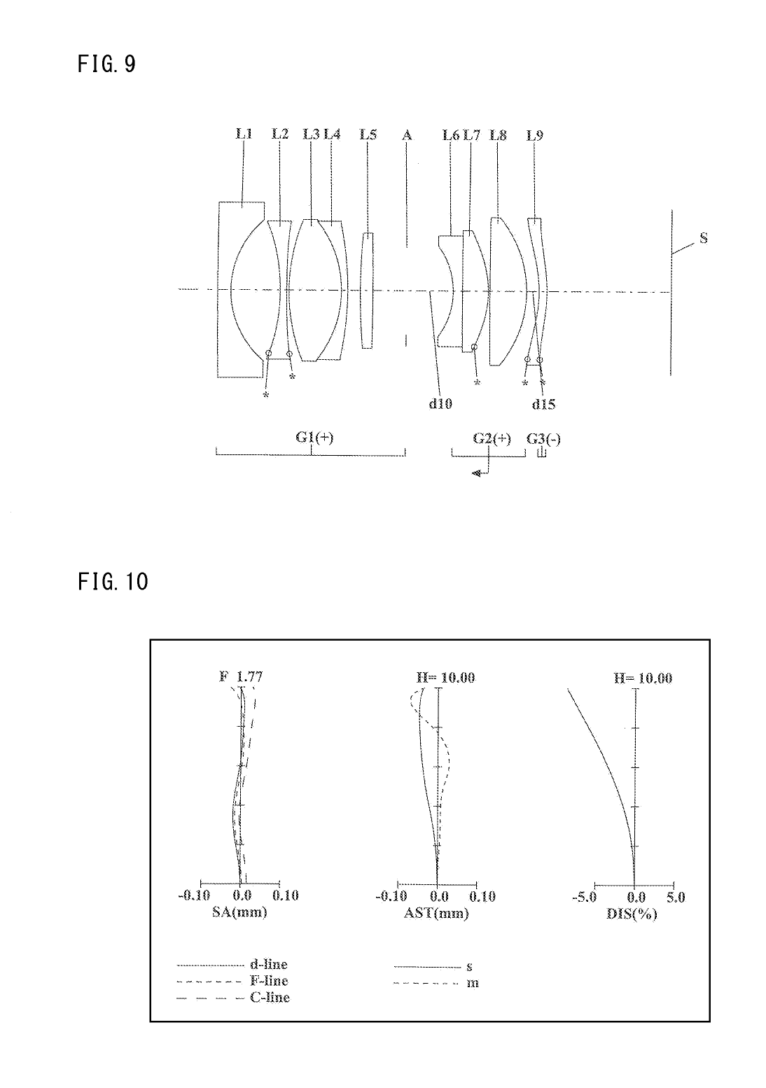

FIG. 9 is a lens arrangement diagram showing an infinity in-focus condition of a single focal length imaging optical system according to Embodiment 5.

The single focal length imaging optical system, in order from the object side to the image side, comprises a first lens unit G1 having positive optical power, an aperture diaphragm A, a second lens unit G2 having positive optical power, and a third lens unit G3 having negative optical power. A front unit is composed of the first lens unit G1, and a rear unit is composed of the second lens unit G2 and the third lens unit G3.

The first lens unit G1, in order from the object side to the image side, comprises: a negative meniscus first lens element L1 with the convex surface facing the object side; a bi-concave second lens element L2; a bi-convex third lens element L3; a negative meniscus fourth lens element L4 with the convex surface facing the image side; and a bi-convex fifth lens element L5. The third lens element L3 and the fourth lens element L4 are cemented with each other.

The second lens unit G2, in order from the object side to the image side, comprises: a bi-concave sixth lens element L6; a bi-convex seventh lens element L7; and a bi-convex eighth lens element L8. The sixth lens element L6 and the seventh lens element L7 are cemented with each other.

The third lens unit G3 comprises solely a negative meniscus ninth lens element L9 with the convex surface facing the image side.

The both surfaces of the second lens element L2, the image side surface of the seventh lens element L7, and the both surfaces of the ninth lens element L9 are aspheric surfaces.

In focusing from an infinity in-focus condition to a close-object in-focus condition, the second lens unit G2 as a focusing lens unit moves to the object side along the optical axis. The first lens unit G1 and the third lens unit G3 are fixed with respect to the image surface S, and do not move in the focusing.

As described above, Embodiments 1 to 5 have been described as examples of art disclosed in the present application. However, the art in the present disclosure is not limited to these embodiments. It is understood that various modifications, replacements, additions, omissions, and the like have been performed in these embodiments to give optional embodiments, and the art in the present disclosure can be applied to the optional embodiments.

The following description is given for conditions that a single focal length imaging optical system like the single focal length imaging optical systems according to Embodiments 1 to 5 can satisfy. A plurality of beneficial conditions is set forth for the single focal length imaging optical system according to each embodiment. A configuration that satisfies all the plurality of conditions is most effective for the single focal length imaging optical system. However, when an individual condition is satisfied, a single focal length imaging optical system having the corresponding effect is obtained.

For example, like the single focal length imaging optical systems according to Embodiments 1 to 5, a single focal length imaging optical system according to the present disclosure, in order from the object side to the image side, comprises: a front unit composed of a plurality of lens elements; an aperture diaphragm; and a rear unit composed of a plurality of lens elements.

The front unit, in order from the object side to the image side, includes: a lens element having negative optical power; a lens element having negative optical power; and a lens element having positive optical power, and further includes a lens element having positive optical power and being placed closest to the image side. The rear unit includes: a focusing lens unit which is composed of at least one lens element and moves along an optical axis in focusing from an infinity in-focus condition to a close-object in-focus condition; and a lens element having negative optical power and being placed closest to the image side. Hereinafter, this lens configuration is referred to as a basic configuration of the embodiments.

It is beneficial for the single focal length imaging optical system having the basic configuration to satisfy the following condition (1):

1.8<nd_{A} (1)

where

nd_{A} is the refractive index to the d-line of the lens element having positive optical power and placed closest to the image side in the front unit.

The condition (1) sets forth the refractive index of the lens element having positive optical power and placed closest to the image side in the front unit. When the value goes below the lower limit of the condition (1), a Petzval sum increases, which makes it difficult to ensure the flatness of the image surface. In other words, when the condition (1) is satisfied, the flatness of the image surface is ensured, and thereby high resolution performance is ensured.

When the following condition (1)′ is satisfied, the above-mentioned effect is achieved more successfully.

1.86<nd_{A} (1)′

It is beneficial for a single focal length imaging optical system having the basic configuration like the single focal length imaging optical systems according to Embodiments 1 to 5 to satisfy the following condition (2):

L/Y<8.0 (2)

where

L is the overall length of the optical system, which is the optical axial distance from the object side surface of the lens element having negative optical power and placed closest to the object side in the front unit, to the image surface, and

Y is the maximum image height.

The condition (2) sets forth a ratio between the overall length of the optical system and the maximum image height. When the value exceeds the upper limit of the condition (2), further miniaturization of the single focal length imaging optical system is difficult. In other words, when the condition (2) is satisfied, further miniaturization of the single focal length imaging optical system is realized.

When the following condition (2)′ is satisfied, the above-mentioned effect is achieved more successfully. In addition, when the value goes below the lower limit of the following condition (2)″, the distance from the front unit to the rear unit is excessively short, which makes it difficult to compensate aberrations, and thereby makes it difficult to ensure high resolution performance.

L/Y<7.0 (2)′

2.0<L/Y (2)″

It is beneficial for a single focal length imaging optical system having the basic configuration like the single focal length imaging optical systems according to Embodiments 1 to 5 to satisfy the following condition (3):

L_{M}/Y<3.5 (3)

where

L_{M} is the optical axial distance from the object side surface of the lens element having negative optical power and placed closest to the object side, to the image side surface of the lens element having positive optical power and placed closest to the image side, which lens elements constitute the front unit, and

Y is the maximum image height.

The condition (3) sets forth a ratio between the length of the front unit and the maximum image height. When the value exceeds the upper limit of the condition (3), the length of the front unit is increased, which makes it difficult to miniaturize the single focal length imaging optical system. In other words, when the condition (3) is satisfied, further miniaturization of the single focal length imaging optical system is realized.

When the following condition (3)′ is satisfied, the above-mentioned effect is achieved more successfully.

L_{M}/Y<2.5 (3)′

It is beneficial for a single focal length imaging optical system having the basic configuration like the single focal length imaging optical systems according to Embodiments 1 to 5 to satisfy the following condition (4):

−0.60<f/f_{B}<−0.05 (4)

where

f is the focal length of the optical system, and

f_{B} is the focal length of the lens element having negative optical power and placed closest to the image side in the rear unit.

The condition (4) sets forth a ratio between the focal length of the entire optical system and the focal length of the lens element having negative optical power and placed closest to the image side in the rear unit. When the value goes below the lower limit of the condition (4), the focal length of the lens element having negative optical power is increased, and the peripheral image surface moves to an over side, which makes it difficult to ensure the flatness of the image surface. When the value exceeds the upper limit of the condition (4), the focal length of the lens element having negative optical power is reduced, and the contraction function of the lens unit located on the object side relative to the lens element having negative optical power is reduced, which makes it difficult to miniaturize the single focal length imaging optical system. In other words, when the condition (4) is satisfied, further miniaturization of the single focal length imaging optical system is realized, and moreover, the flatness of the image surface is ensured, and thereby high resolution performance is ensured.

When at least one of the following conditions (4)′ and (4)″ is satisfied, the above-mentioned effect is achieved more successfully.

−0.40<f/f_{B} (4)′

f/f_{B}<−0.10 (4)″

It is beneficial for a single focal length imaging optical system having the basic configuration like the single focal length imaging optical systems according to Embodiments 1 to 5 to satisfy the following condition (5):

0.03<f/f_{A}<0.50 (5)

where

f is the focal length of the optical system, and

f_{A} is the focal length of the lens element having positive optical power and placed closest to the image side in the front unit.

The condition (5) sets forth a ratio between the focal length of the entire optical system and the focal length of the lens element having positive optical power and placed closest to the image side in the front unit. When the value goes below the lower limit of the condition (5), the effect for compensating spherical aberration that occurs in the lens element having positive optical power is reduced, which makes it difficult to compensate spherical aberration in the rear unit. When the value exceeds the upper limit of the condition (5), compensation of spherical aberration that occurs in the lens element having positive optical power excessively acts in an under direction, which makes it difficult to compensate spherical aberration in the rear unit. In other words, when the condition (5) is satisfied, successful compensation of spherical aberration is realized, and thereby high resolution performance is ensured.

When at least one of the following conditions (5)′ and (5)″ is satisfied, the above-mentioned effect is achieved more successfully.

0.08<f/f_{A} (5)′

f/f_{A}<0.43 (5)″

It is beneficial for a single focal length imaging optical system having the basic configuration like the single focal length imaging optical systems according to Embodiments 1 to 5 to satisfy the following condition (6):

1.00<f_{M}/f<3.50 (6)

where

f is the focal length of the optical system, and

f_{M} is the focal length of the front unit.

The condition (6) sets forth a ratio between the focal length of the entire optical system and the focal length of the front unit. When the value goes below the lower limit of the condition (6), the optical power of the front unit becomes excessively strong, and curvature of field that occurs in the front unit becomes excessive in the under direction, which makes it difficult to compensate curvature of field in the rear unit. When the value exceeds the upper limit of the condition (6), the focal length of the front unit is increased, which makes it difficult to miniaturize the single focal length imaging optical system. In other words, when the condition (6) is satisfied, successful compensation of curvature of field and further miniaturization are realized, and thereby high resolution performance is ensured.

When at least one of the following conditions (6)′ and (6)″ is satisfied, the above-mentioned effect is achieved more successfully.

1.50<f_{M}/f (6)′

f_{M}/f<2.70 (6)″

It is beneficial for a single focal length imaging optical system having the basic configuration like the single focal length imaging optical systems according to Embodiments 1 to 5 to satisfy the following condition (7):

0.25<nd_{MMAX}−nd_{MMIN}<0.60 (7)

where

nd_{MMAX} is the maximum value of the refractive index to the d-line of each lens element constituting the front unit, and

nd_{MMIN} is the minimum value of the refractive index to the d-line of each lens element constituting the front unit.

The condition (7) sets forth a difference between the maximum value and the minimum value of the refractive index to the d-line of each lens element constituting the front unit. When the value goes below the lower limit of the condition (7), curvature of field that occurs in the front unit becomes excessive in the under direction, which makes it difficult to maintain the flatness of the image surface. When the value exceeds the upper limit of the condition (7), the curvature of field that occurs in the front unit becomes excessive in an over direction, which makes it difficult to maintain the flatness of the image surface. In other words, when the condition (7) is satisfied, the flatness of the image surface is maintained, and thereby high resolution performance is ensured.

When at least one of the following conditions (7)′ and (7)″ is satisfied, the above-mentioned effect is achieved more successfully.

0.35<nd_{MMAX}−nd_{MMIN} (7)′

nd_{MMAX}−nd_{MMIN}<0.55 (7)″

It is beneficial that the lens element having the maximum refractive index (nd_{MMAX}) to the d-line among the lens elements constituting the front unit is the lens element having positive optical power and placed closest to the image side. Thereby, both the spherical aberration and the flatness of the image surface can be compensated more successfully with less number of lens elements, and thus higher resolution performance is ensured.

Further, it is beneficial that the lens element having the minimum refractive index (nd_{MMIN}) to the d-line among the lens elements constituting the front unit is the lens element having negative optical power and placed closest to the object side. Thereby, the spherical aberration in the front unit can be compensated within a more appropriate range.

It is beneficial for the lens element having negative optical power and placed closest to the image side in the rear unit to be a single lens element, in terms of shortening of the overall length of the optical system.

It is beneficial for the lens element having negative optical power and placed closest to the image side in the rear unit to be a lens element having a concave surface facing the object side, in terms of ensuring of back focal distance.

It is beneficial for the lens element having negative optical power and placed closest to the image side in the rear unit to be a meniscus lens element having a concave surface facing the object side, in the viewpoint that excessive plus compensation of the image surface is suppressed.

It is beneficial for the lens element placed closest to the object side among the lens elements constituting the focusing lens unit to be a lens element having negative optical power and a concave surface facing the object side, in the viewpoint that spherical aberration is successfully compensated from a close region to a far region.

The individual lens units constituting the single focal length imaging optical systems according to Embodiments 1 to 5 are each composed exclusively of refractive type lens elements that deflect incident light by refraction (that is, lens elements of a type in which deflection is achieved at the interface between media having different refractive indices). However, the present disclosure is not limited to this construction. For example, the lens units may employ diffractive type lens elements that deflect incident light by diffraction; refractive-diffractive hybrid type lens elements that deflect incident light by a combination of diffraction and refraction; or gradient index type lens elements that deflect incident light by distribution of refractive index in the medium. In particular, in the refractive-diffractive hybrid type lens element, when a diffraction structure is formed in the interface between media having different refractive indices, wavelength dependence of the diffraction efficiency is improved. Thus, such a configuration is beneficial.

### Embodiment 6

### Camera System

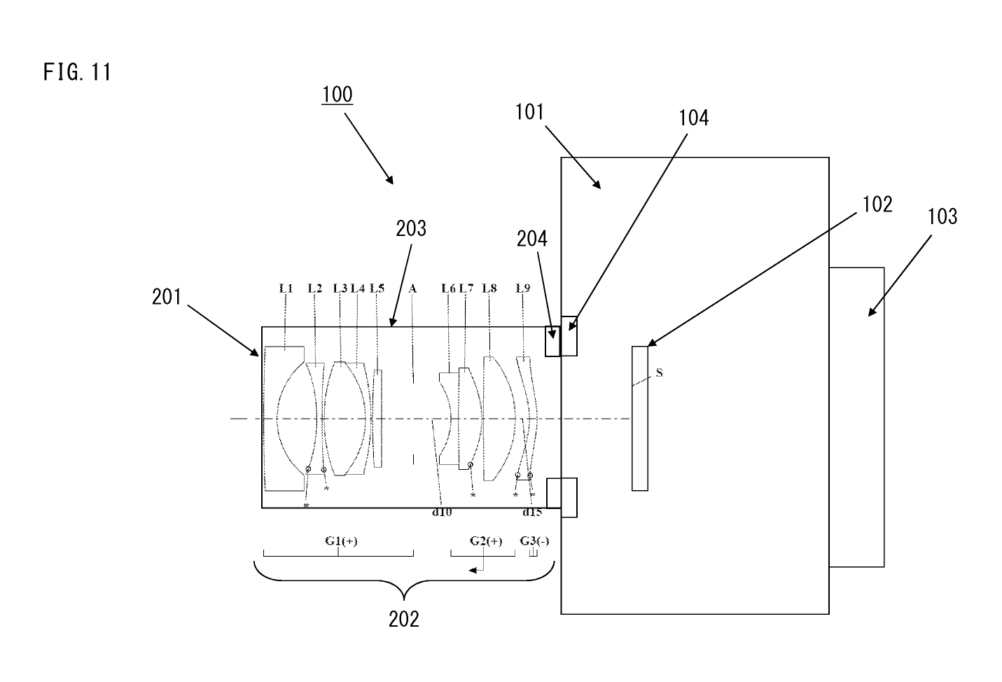

FIG. 11 is a schematic construction diagram of an interchangeable-lens type digital camera system adopting the single focal length imaging optical system according to Embodiment 1. In the interchangeable-lens type digital camera system according to Embodiment 6, any one of the single focal length imaging optical systems according to Embodiments 2 to 5 can be adopted instead of the single focal length imaging optical system according to Embodiment 1.

The interchangeable-lens type digital camera system 100 according to Embodiment 6 includes a camera body 101, and an interchangeable lens apparatus 201 which is detachably connected to the camera body 101.

The camera body 101 includes: an image sensor 102 which receives an optical image formed by a single focal length imaging optical system 202 of the interchangeable lens apparatus 201, and converts the optical image into an electric image signal; a liquid crystal monitor 103 which displays the image signal obtained by the image sensor 102; and a camera mount section 104. On the other hand, the interchangeable lens apparatus 201 includes: a single focal length imaging optical system 202 according to Embodiment 1; a lens barrel 203 which holds the single focal length imaging optical system 202; and a lens mount section 204 connected to the camera mount section 104 of the camera body 101. The camera mount section 104 and the lens mount section 204 are physically connected to each other. Moreover, the camera mount section 104 and the lens mount section 204 function as interfaces which allow the camera body 101 and the interchangeable lens apparatus 201 to exchange signals, by electrically connecting a controller (not shown) in the camera body 101 and a controller (not shown) in the interchangeable lens apparatus 201.

Embodiment 6 represents an example of an embodiment in which the single focal length imaging optical system according to Embodiment 1 is adopted for an interchangeable-lens type digital camera system. The single focal length imaging optical system according to the present disclosure can be adopted for a smart-phone, a digital camera, a vehicle-mounted camera, or the like.

As described above, Embodiment 6 has been described as an example of art disclosed in the present application. However, the art in the present disclosure is not limited to this embodiment. It is understood that various modifications, replacements, additions, omissions, and the like have been performed in this embodiment to give optional embodiments, and the art in the present disclosure can be applied to the optional embodiments.

Numerical examples are described below in which the single focal length imaging optical systems according to Embodiments 1 to 5 are implemented. Here, in the numerical examples, the units of length are all “mm”, while the units of view angle are all “°”. Moreover, in the numerical examples, r is the radius of curvature, d is the axial distance, nd is the refractive index to the d-line, and vd is the Abbe number to the d-line. In the numerical examples, the surfaces marked with * are aspherical surfaces, and the aspherical surface configuration is defined by the following expression.

$$Z = \frac{{h}^{2} / r}{1 + \sqrt{1 - ( 1 + κ ) {( h / r )}^{2}}} + \sum {A}_{n} {h}^{n}$$

Here, the symbols in the formula indicate the following quantities.

Z is a distance from a point on an aspherical surface at a height h relative to the optical axis to a tangential plane at the vertex of the aspherical surface,

h is a height relative to the optical axis,

r is a radius of curvature at the top,

κ is a conic constant, and

Aₙ is a n-th order aspherical coefficient.

FIGS. 2, 4, 6, 8 and 10 are longitudinal aberration diagrams of the infinity in-focus condition of the single focal length imaging optical systems according to Numerical Examples 1 to 5, respectively.

Each longitudinal aberration diagram, in order from the left-hand side, shows the spherical aberration (SA (mm)), the astigmatism (AST (mm)) and the distortion (DIS (%)). In each spherical aberration diagram, the vertical axis indicates the F-number (in each Fig., indicated as F), and the solid line, the short dash line and the long dash line indicate the characteristics to the d-line, the F-line and the C-line, respectively. In each astigmatism diagram, the vertical axis indicates the image height (in each Fig., indicated as H), and the solid line and the dash line indicate the characteristics to the sagittal plane (in each Fig., indicated as “s”) and the meridional plane (in each Fig., indicated as “m”), respectively. In each distortion diagram, the vertical axis indicates the image height (in each Fig., indicated as H).

### Numerical Example 1

The single focal length imaging optical system of Numerical Example 1 corresponds to Embodiment 1 shown in FIG. 1. Table 1 shows the surface data of the single focal length imaging optical system of Numerical Example 1. Table 2 shows the aspherical data. Table 3 shows the various data. Table 4 shows the single lens data. Table 5 shows the lens unit data.

TABLE 1
(Surface data)

| Surface number | r | d | nd | vd |
|---|---|---|---|---|
| Object surface | ∞ | ∞ | | |
| 1 | 265.86710 | 2.00000 | 1.49771 | 80.9 |
| 2 | 10.87030 | 5.94630 | | |
| 3* | −25.35800 | 0.80000 | 1.58245 | 42.3 |
| 4* | 141.62380 | 0.30000 | | |
| 5 | 23.74970 | 6.20020 | 1.88331 | 40.8 |
| 6 | −12.80890 | 0.80000 | 1.75220 | 25.9 |
| 7 | −31.08880 | 0.25000 | | |
| 8 | 113.91580 | 1.31840 | 1.89591 | 38.9 |
| 9 | 2264.41880 | 4.74030 | | |
| 10(Diaphragm) | ∞ | 5.66050 | | |
| 11 | −9.83920 | 1.14400 | 1.78447 | 25.5 |
| 12 | 241.81840 | 3.49390 | 1.77050 | 49.5 |
| 13* | −12.35640 | 0.20000 | | |
| 14 | 372.55590 | 4.80000 | 1.77327 | 49.2 |
| 15 | −14.42300 | 2.12530 | | |
| 16* | −10.59880 | 1.11500 | 1.68597 | 30.2 |
| 17* | −14.59880 | 14.28440 | | |
| 18 | ∞ | (BF) | | |
| Image surface | ∞ | | | |

TABLE 2
(Aspherical data)

Surface No. 3
K = 5.26955E+00, A4 = −2.92075E−05, A6 = 1.38444E−06,
A8 = −2.93393E−08 A10 = 3.68972E−10, A12 = −1.44226E−12,
A14 = 0.00000E+00, A16 = 0.00000E+00 A18 = 0.00000E+00
Surface No. 4
K = 0.00000E+00, A4 = −2.53972E−05, A6 = 1.59656E−06,
A8 = −3.59892E−08 A10 = 4.85159E−10, A12 = −2.28874E−12,
A14 = 0.00000E+00, A16 = 0.00000E+00 A18 = 0.00000E+00
Surface No. 13
K = 0.00000E+00, A4 = 1.32993E−04, A6 = 1.81647E−06,
A8 = −1.16782E−07 A10 = 4.55439E−09, A12 = −7.07902E−11,
A14 = −1.77174E−13, A16 = 1.87817E−14 A18 = −1.60689E−16
Surface No. 16
K = 0.00000E+00, A4 = 8.48336E−04, A6 = −1.50621E−05,
A8 = 2.75444E−07 A10 = −3.51854E−09, A12 = 3.07443E−11,
A14 = −1.22206E−13, A16 = 0.00000E+00 A18 = 0.00000E+00
Surface No. 17
K = 0.00000E+00, A4 = 6.81191E−04, A6 = −1.31605E−05,
A8 = 2.44461E−07 A10 = −3.35082E−09, A12 = 3.03420E−11,
A14 = −1.23799E−13, A16 = 0.00000E+00 A18 = 0.00000E+00

TABLE 3
(Various data)

| | |
|---|---|
| Focal length | 14.8806 |
| F-number | 1.76549 |
| Half view angle | 36.3388 |
| Image height | 10.0000 |
| Overall length of optical system | 55.1784 |
| BF | 0.00008 |
| Entrance pupil position | 11.7571 |
| Exit pupil position | −47.5098 |
| Front principal points position | 21.9769 |
| Back principal points position | 40.2978 |

TABLE 4
(Single lens data)

| Lens | Initial surface | Focal |
|---|---|---|
| element | number | length |
| 1 | 1 | −22.8310 |
| 2 | 3 | −36.8606 |
| 3 | 5 | 10.2345 |
| 4 | 6 | −29.5153 |
| 5 | 8 | 133.8471 |
| 6 | 11 | −12.0280 |
| 7 | 12 | 15.3490 |
| 8 | 14 | 18.0545 |
| 9 | 16 | −63.6047 |

TABLE 5
(Lens unit data)

| | Initial | | Overall | | |
|---|---|---|---|---|---|
| Lens | surface | Focal | length of | Front principal | Back principal |
| unit | No. | length | lens unit | points position | points position |
| 1 | 1 | 32.87865 | 22.35520 | 18.32279 | 30.55924 |
| 2 | 11 | 15.82169 | 9.63790 | 6.93867 | 13.03395 |
| 3 | 16 | −63.60474 | 1.11500 | −1.97652 | −1.60746 |

### Numerical Example 2

The single focal length imaging optical system of Numerical Example 2 corresponds to Embodiment 2 shown in FIG. 3. Table 6 shows the surface data of the single focal length imaging optical system of Numerical Example 2. Table 7 shows the aspherical data. Table 8 shows the various data. Table 9 shows the single lens data. Table 10 shows the lens unit data.

TABLE 6
(Surface data)

| Surface number | r | d | nd | vd |
|---|---|---|---|---|
| Object surface | ∞ | ∞ | | |
| 1 | −261.10280 | 1.32110 | 1.49913 | 80.1 |
| 2 | 11.74920 | 5.54980 | | |
| 3* | −26.35970 | 0.80000 | 1.58542 | 41.7 |
| 4* | 124.64120 | 0.30000 | | |
| 5 | 23.68830 | 5.99430 | 1.88234 | 40.8 |
| 6 | −13.12240 | 0.80000 | 1.75409 | 26.0 |
| 7 | −57.61710 | 0.25000 | | |
| 8 | 81.14030 | 1.97780 | 1.91597 | 36.4 |
| 9 | −84.53380 | 4.51110 | | |
| 10(Diaphragm) | ∞ | 5.86550 | | |
| 11 | −9.85960 | 1.02240 | 1.78630 | 27.5 |
| 12 | 72.37940 | 3.36800 | 1.76864 | 49.7 |
| 13* | −12.56180 | 0.20430 | | |
| 14 | 5229.98160 | 4.50900 | 1.77074 | 49.5 |
| 15 | −14.07080 | 2.10010 | | |
| 16* | −10.51570 | 1.01130 | 1.69748 | 29.0 |
| 17* | −14.51570 | 14.23040 | | |
| 18 | ∞ | (BF) | | |
| Image surface | ∞ | | | |

TABLE 7
(Aspherical data)

Surface No. 3
K = 5.18341E+00, A4 = −2.39853E−05, A6 = 1.51467E−06,
A8 = −2.84434E−08 A10 = 3.40010E−10, A12 = −1.36175E−12,
A14 = 0.00000E+00, A16 = 0.00000E+00 A18 = 0.00000E+00
Surface No. 4
K = 0.00000E+00, A4 = −2.02569E−05, A6 = 1.67870E−06,
A8 = −3.65979E−08 A10 = 4.84842E−10, A12 = −2.36003E−12,
A14 = 0.00000E+00, A16 = 0.00000E+00 A18 = 0.00000E+00
Surface No. 13
K = 0.00000E+00, A4 = 1.26458E−04, A6 = 1.79290E−06,
A8 = −1.16002E−07 A10 = 4.53927E−09, A12 = −7.11480E−11,
A14 = −1.77737E−13, A16 = 1.87772E−14 A18 = −1.59045E−16
Surface No. 16
K = 0.00000E+00, A4 = 8.41464E−04, A6 = −1.50602E−05,
A8 = 2.74677E−07 A10 = −3.52174E−09, A12 = 3.09424E−11,
A14 = −1.23311E−13, A16 = 0.00000E+00 A18 = 0.00000E+00
Surface No. 17
K = 0.00000E+00, A4 = 6.85533E−04, A6 = −1.32978E−05,
A8 = 2.44739E−07 A10 = −3.34871E−09, A12 = 3.02662E−11,
A14 = −1.23632E−13, A16 = 0.00000E+00 A18 = 0.00000E+00

TABLE 8
(Various data)

| | |
|---|---|
| Focal length | 15.4836 |
| F-number | 1.76542 |
| Half view angle | 35.2560 |
| Image height | 10.0000 |
| Overall length of optical system | 53.8153 |
| BF | 0.00022 |
| Entrance pupil position | 11.0525 |
| Exit pupil position | −44.6554 |
| Front principal points position | 21.1674 |
| Back principal points position | 38.3317 |

TABLE 9
(Single lens data)

| Lens | Initial surface | Focal |
|---|---|---|
| element | number | length |
| 1 | 1 | −22.4895 |
| 2 | 3 | −37.0945 |
| 3 | 5 | 10.3614 |
| 4 | 6 | −22.7094 |
| 5 | 8 | 45.4585 |
| 6 | 11 | −10.9758 |
| 7 | 12 | 14.1702 |
| 8 | 14 | 18.2141 |
| 9 | 16 | −61.0548 |

TABLE 10
(Lens unit data)

| | Initial | | Overall | | |
|---|---|---|---|---|---|
| Lens | surface | Focal | length of | Front principal | Back principal |
| unit | No. | length | lens unit | points position | points position |
| 1 | 1 | 29.74355 | 21.50410 | 16.77018 | 28.58252 |
| 2 | 11 | 16.64412 | 9.10370 | 6.91207 | 12.69855 |
| 3 | 16 | −61.05483 | 1.01130 | −1.74779 | −1.40132 |

### Numerical Example 3

The single focal length imaging optical system of Numerical Example 3 corresponds to Embodiment 3 shown in FIG. 5. Table 11 shows the surface data of the single focal length imaging optical system of Numerical Example 3. Table 12 shows the aspherical data. Table 13 shows the various data. Table 14 shows the single lens data. Table 15 shows the lens unit data.

TABLE 11
(Surface data)

| Surface number | r | d | nd | vd |
|---|---|---|---|---|
| Object surface | ∞ | ∞ | | |
| 1 | 405.29050 | 2.00000 | 1.49717 | 81.4 |
| 2 | 10.97740 | 5.68020 | | |
| 3* | −24.48180 | 0.80000 | 1.58214 | 42.4 |
| 4* | 177.31850 | 0.30000 | | |
| 5 | 23.49370 | 5.98900 | 1.88302 | 40.8 |
| 6 | −12.95940 | 0.80000 | 1.75206 | 25.9 |
| 7 | −39.29270 | 0.25000 | | |
| 8 | 87.21590 | 1.61560 | 1.91091 | 37.0 |
| 9 | −254.38400 | 4.46310 | | |
| 10(Diaphragm) | ∞ | 5.88290 | | |
| 11 | −9.88090 | 1.12160 | 1.78476 | 24.9 |
| 12 | 372.12470 | 3.23340 | 1.76996 | 49.6 |
| 13* | −12.16270 | 0.20000 | | |
| 14 | 1980.42100 | 4.65850 | 1.77213 | 49.3 |
| 15 | −13.83580 | 2.11440 | | |
| 16* | −10.33870 | 0.80000 | 1.71739 | 40.0 |
| 17* | −15.18030 | 14.28280 | | |
| 18 | ∞ | (BF) | | |
| Image surface | ∞ | | | |

TABLE 12
(Aspherical data)

Surface No. 3
K = 5.88703E+00, A4 = −1.54646E−05, A6 = 1.55857E−06,
A8 = −2.50851E−08 A10 = 2.95384E−10, A12 = −4.18720E−13,
A14 = 0.00000E+00, A16 = 0.00000E+00 A18 = 0.00000E+00
Surface No. 4
K = 0.00000E+00, A4 = −2.37668E−05, A6 = 1.62512E−06,
A8 = −3.66627E−08 A10 = 5.15816E−10, A12 = −2.60970E−12,
A14 = 0.00000E+00, A16 = 0.00000E+00 A18 = 0.00000E+00
Surface No. 13
K = 0.00000E+00, A4 = 1.31113E−04, A6 = 2.00174E−06,
A8 = −1.13933E−07 A10 = 4.53198E−09, A12 = −7.16030E−11,
A14 = −1.76478E−13, A16 = 1.90413E−14 A18 = −1.62008E−16
Surface No. 16
K = 0.00000E+00, A4 = 8.48243E−04, A6 = −1.50149E−05,
A8 = 2.72032E−07 A10 = −3.49378E−09, A12 = 3.10040E−11,
A14 = −1.22688E−13, A16 = 0.00000E+00 A18 = 0.00000E+00
Surface No. 17
K = 0.00000E+00, A4 = 6.79990E−04, A6 = −1.35658E−05,
A8 = 2.46460E−07 A10 = −3.35886E−09, A12 = 3.02888E−11,
A14 = −1.23074E−13, A16 = 0.00000E+00 A18 = 0.00000E+00

TABLE 13
(Various data)

| | |
|---|---|
| Focal length | 15.5323 |
| F-number | 1.76558 |
| Half view angle | 35.1734 |
| Image height | 10.0000 |
| Overall length of optical system | 54.1917 |
| BF | 0.00019 |
| Entrance pupil position | 11.5305 |
| Exit pupil position | −42.9646 |
| Front principal points position | 21.4477 |
| Back principal points position | 38.6594 |

TABLE 14
(Single lens data)

| Lens | Initial surface | Focal |
|---|---|---|
| element | number | length |
| 1 | 1 | −22.7330 |
| 2 | 3 | −36.8989 |
| 3 | 5 | 10.2482 |
| 4 | 6 | −26.0520 |
| 5 | 8 | 71.4612 |
| 6 | 11 | −12.2495 |
| 7 | 12 | 15.3528 |
| 8 | 14 | 17.8129 |
| 9 | 16 | −48.5358 |

TABLE 15
(Lens unit data)

| | Initial | | Overall | | |
|---|---|---|---|---|---|
| Lens | surface | Focal | length of | Front principal | Back principal |
| unit | No. | length | lens unit | points position | points position |
| 1 | 1 | 31.26715 | 21.89790 | 17.54280 | 29.34148 |
| 2 | 11 | 15.65365 | 9.21350 | 6.67835 | 12.41667 |
| 3 | 16 | −48.53579 | 0.80000 | −1.06846 | −0.76882 |

### Numerical Example 4

The single focal length imaging optical system of Numerical Example 4 corresponds to Embodiment 4 shown in FIG. 7. Table 16 shows the surface data of the single focal length imaging optical system of Numerical Example 4. Table 17 shows the aspherical data. Table 18 shows the various data. Table 19 shows the single lens data. Table 20 shows the lens unit data.

TABLE 16
(Surface data)

| Surface number | r | d | nd | vd |
|---|---|---|---|---|
| Object surface | ∞ | ∞ | | |
| 1 | 405.29050 | 2.00000 | 1.49717 | 81.4 |
| 2 | 10.97740 | 5.68020 | | |
| 3* | −24.48180 | 0.80000 | 1.58214 | 42.4 |
| 4* | 177.31850 | 0.30000 | | |
| 5 | 23.49370 | 5.98900 | 1.88302 | 40.8 |
| 6 | −12.95940 | 0.80000 | 1.75206 | 25.9 |
| 7 | −39.29270 | 0.25000 | | |
| 8 | 87.21590 | 1.61560 | 1.91091 | 37.0 |
| 9 | −254.38400 | 4.46310 | | |
| 10(Diaphragm) | ∞ | 5.88290 | | |
| 11 | −9.88090 | 1.12160 | 1.78476 | 24.9 |
| 12 | 372.12470 | 3.23340 | 1.76996 | 49.6 |
| 13* | −12.16270 | 0.20000 | | |
| 14 | 1980.42100 | 4.65850 | 1.77213 | 49.3 |
| 15 | −13.83580 | 2.11440 | | |
| 16* | −10.33870 | 0.80000 | 1.71739 | 40.0 |
| 17* | −15.18030 | 14.28280 | | |
| 18 | ∞ | (BF) | | |
| Image surface | ∞ | | | |

TABLE 17
(Aspherical data)

Surface No. 3
K = 5.88703E+00, A4 = −1.54646E−05, A6 = 1.55857E−06,
A8 = −2.50851E−08 A10 = 2.95384E−10, A12 = −4.18720E−13,
A14 = 0.00000E+00, A16 = 0.00000E+00 A18 = 0.00000E+00
Surface No. 4
K = 0.00000E+00, A4 = −2.37668E−05, A6 = 1.62512E−06,
A8 = −3.66627E−08 A10 = 5.15816E−10, A12 = −2.60970E−12,
A14 = 0.00000E+00, A16 = 0.00000E+00 A18 = 0.00000E+00
Surface No. 13
K = 0.00000E+00, A4 = 1.31113E−04, A6 = 2.00174E−06,
A8 = −1.13933E−07 A10 = 4.53198E−09, A12 = −7.16030E−11,
A14 = −1.76478E−13, A16 = 1.90413E−14 A18 = −1.62008E−16
Surface No. 16
K = 0.00000E+00, A4 = 8.48243E−04, A6 = −1.50149E−05,
A8 = 2.72032E−07 A10 = −3.49378E−09, A12 = 3.10040E−11,
A14 = −1.22688E−13, A16 = 0.00000E+00 A18 = 0.00000E+00
Surface No. 17
K = 0.00000E+00, A4 = 6.79990E−04, A6 = −1.35658E−05,
A8 = 2.46460E−07 A10 = −3.35886E−09, A12 = 3.02888E−11,
A14 = −1.23074E−13, A16 = 0.00000E+00 A18 = 0.00000E+00

TABLE 18
(Various data)

| | |
|---|---|
| Focal length | 15.5323 |
| F-number | 1.76558 |
| Half view angle | 35.1734 |
| Image height | 10.0000 |
| Overall length of optical system | 54.1917 |
| BF | 0.00019 |
| Entrance pupil position | 11.5305 |
| Exit pupil position | −42.9646 |
| Front principal points position | 21.4477 |
| Back principal points position | 38.6594 |

TABLE 19
(Single lens data)

| Lens | Initial surface | Focal |
|---|---|---|
| element | number | length |
| 1 | 1 | −22.7330 |
| 2 | 3 | −36.8989 |
| 3 | 5 | 10.2482 |
| 4 | 6 | −26.0520 |
| 5 | 8 | 71.4612 |
| 6 | 11 | −12.2495 |
| 7 | 12 | 15.3528 |
| 8 | 14 | 17.8129 |
| 9 | 16 | −48.5358 |

TABLE 20
(Lens unit data)

| | Initial | | Overall | | |
|---|---|---|---|---|---|
| Lens | surface | Focal | length of | Front principal | Back principal |
| unit | No. | length | lens unit | points position | points position |
| 1 | 1 | 31.26715 | 21.89790 | 17.54280 | 29.34148 |
| 2 | 11 | 15.65365 | 9.21350 | 6.67835 | 12.41667 |
| 3 | 16 | −48.53579 | 0.80000 | −1.06846 | −0.76882 |

### Numerical Example 5

The single focal length imaging optical system of Numerical Example 5 corresponds to Embodiment 5 shown in FIG. 9. Table 21 shows the surface data of the single focal length imaging optical system of Numerical Example 5. Table 22 shows the aspherical data. Table 23 shows the various data. Table 24 shows the single lens data. Table 25 shows the lens unit data.

TABLE 21
(Surface data)

| Surface number | r | d | nd | vd |
|---|---|---|---|---|
| Object surface | ∞ | ∞ | | |
| 1 | 663.71310 | 1.65190 | 1.49761 | 81.5 |
| 2 | 11.65080 | 6.22520 | | |
| 3* | −23.95020 | 0.82080 | 1.58158 | 42.5 |
| 4* | 134.05620 | 0.30000 | | |
| 5 | 23.75210 | 6.66300 | 1.88317 | 40.8 |
| 6 | −13.94970 | 0.80000 | 1.75187 | 25.9 |
| 7 | −40.14990 | 1.61660 | | |
| 8 | 82.23090 | 1.60060 | 1.90949 | 37.1 |
| 9 | −304.81200 | 4.27400 | | |
| 10(Diaphragm) | ∞ | 5.95480 | | |
| 11 | −9.50890 | 1.16610 | 1.78602 | 25.5 |
| 12 | 995.10510 | 3.25730 | 1.76959 | 49.6 |
| 13* | −12.79630 | 0.20000 | | |
| 14 | 812.88330 | 4.61800 | 1.77105 | 49.4 |
| 15 | −14.59310 | 1.60990 | | |
| 16* | −14.24550 | 1.00000 | 1.68965 | 29.5 |
| 17* | −18.90700 | 15.73130 | | |
| 18 | ∞ | (BF) | | |
| Image surface | ∞ | | | |

TABLE 22
(Aspherical data)

Surface No. 3
K = 5.36817E+00, A4 = 7.29478E−05, A6 = −8.07675E−07,
A8 = 2.87992E−08 A10 = −4.68183E−10, A12 = 3.82501E−12,
A14 = 0.00000E+00, A16 = 0.00000E+00 A18 = 0.00000E+00
Surface No. 4
K = 0.00000E+00, A4 = 4.85016E−05, A6 = −2.96978E−07,
A8 = 1.33048E−09 A10 = −6.51260E−12, A12 = 3.38860E−13,
A14 = 0.00000E+00, A16 = 0.00000E+00 A18 = 0.00000E+00
Surface No. 13
K = 0.00000E+00, A4 = 1.13439E−04, A6 = 1.42477E−06,
A8 = −1.01987E−07 A10 = 4.16731E−09, A12 = −6.78839E−11,
A14 = −8.31065E−14, A16 = 1.56679E−14 A18 = −1.32504E−16
Surface No. 16
K = 0.00000E+00, A4 = 4.77181E−04, A6 = −8.27137E−06,
A8 = 1.86756E−07 A10 = −3.15816E−09, A12 = 3.14139E−11,
A14 = −1.28778E−13, A16 = 0.00000E+00 A18 = 0.00000E+00
Surface No. 17
K = 0.00000E+00, A4 = 4.04199E−04, A6 = −7.64059E−06,
A8 = 1.85617E−07 A10 = −3.19333E−09, A12 = 3.12368E−11,
A14 = −1.24549E−13, A16 = 0.00000E+00 A18 = 0.00000E+00

TABLE 23
(Various data)

| | |
|---|---|
| Focal length | 15.2879 |
| F-number | 1.76559 |
| Half view angle | 35.6011 |
| Image height | 10.0000 |
| Overall length of optical system | 57.4896 |
| BF | 0.00010 |
| Entrance pupil position | 12.3137 |
| Exit pupil position | −49.5823 |
| Front principal points position | 22.8879 |
| Back principal points position | 42.2017 |

TABLE 24
(Single lens data)

| Lens | Initial surface | Focal |
|---|---|---|
| element | number | length |
| 1 | 1 | −23.8521 |
| 2 | 3 | −34.8725 |
| 3 | 5 | 10.8501 |
| 4 | 6 | −28.8091 |
| 5 | 8 | 71.3456 |
| 6 | 11 | −11.9768 |
| 7 | 12 | 16.4394 |
| 8 | 14 | 18.6378 |
| 9 | 16 | −91.8208 |

TABLE 25
(Lens unit data)

| | Initial | | Overall | | |
|---|---|---|---|---|---|
| Lens | surface | Focal | length of | Front principal | Back principal |
| unit | No. | length | lens unit | points position | points position |
| 1 | 1 | 32.30798 | 23.95210 | 18.94522 | 32.29628 |
| 2 | 11 | 17.83086 | 9.24140 | 7.31043 | 13.37166 |
| 3 | 16 | −91.82079 | 1.00000 | −1.98222 | −1.63085 |

The following Table 26 shows the corresponding values to the individual conditions in the single focal length imaging optical systems of each of Numerical Examples.

TABLE 26
(Values corresponding to conditions)

| | | Numerical Example | | | | |
|---|---|---|---|---|---|---|
| Condition | | 1 | 2 | 3 | 4 | 5 |
| (1) | nd_{A} | 1.90 | 1.92 | 1.91 | 1.91 | 1.91 |
| (2) | L/Y | 5.50 | 5.36 | 5.45 | 5.40 | 5.73 |
| (3) | L_{M}/Y | 1.76 | 1.69 | 1.74 | 1.74 | 1.96 |
| (4) | f/f_{B} | −0.23 | −0.25 | −0.24 | −0.32 | −0.17 |
| (5) | f/f_{A} | 0.11 | 0.34 | 0.21 | 0.22 | 0.21 |
| (6) | f_{M}/f | 2.21 | 1.92 | 2.10 | 2.01 | 2.11 |
| (7) | nd_{MMAX}-nd_{MMIN} | 0.40 | 0.42 | 0.50 | 0.41 | 0.41 |

The single focal length imaging optical system according to the present disclosure is applicable to, for example, an interchangeable-lens type camera, a compact camera, a camera for a mobile terminal device such as a smart-phone, a Web camera, a surveillance camera in a surveillance system, a vehicle-mounted camera or the like. In particular, the single focal length imaging optical system according to the present disclosure is applicable to a camera, such as an interchangeable-lens type camera, which is bright because having a small F-number, and in which miniaturization is required.

As described above, embodiments have been described as examples of art in the present disclosure. Thus, the attached drawings and detailed description have been provided.

Therefore, in order to illustrate the art, not only essential elements for solving the problems but also elements that are not necessary for solving the problems may be included in elements appearing in the attached drawings or in the detailed description. Therefore, such unnecessary elements should not be immediately determined as necessary elements because of their presence in the attached drawings or in the detailed description.

Further, since the embodiments described above are merely examples of the art in the present disclosure, it is understood that various modifications, replacements, additions, omissions, and the like can be performed in the scope of the claims or in an equivalent scope thereof.

What is claimed is:

1. A single focal length imaging optical system, in order from an object side to an image side, comprising: a front unit composed of a plurality of lens elements; an aperture diaphragm; and a rear unit composed of a plurality of lens elements, wherein
the front unit, in order from the object side to the image side, includes a lens element having negative optical power, a lens element having negative optical power, and a lens element having positive optical power, and includes a lens element having positive optical power and placed closest to the image side, and
the rear unit includes a focusing lens unit which is composed of at least one lens element and moves along an optical axis in focusing from an infinity in-focus condition to a close-object in-focus condition, and a lens element having negative optical power and placed closest to the image side.

2. The single focal length imaging optical system as claimed in claim 1, satisfying the following condition (1):
1.8<nd_{A} (1)
where
nd_{A} is a refractive index to a d-line of the lens element having positive optical power and placed closest to the image side in the front unit.

3. The single focal length imaging optical system as claimed in claim 1, satisfying the following condition (2):
L/Y<8.0 (2)
where
L is an overall length of the optical system, which is an optical axial distance from an object side surface of the lens element having negative optical power and placed closest to the object side in the front unit, to an image surface, and
Y is a maximum image height.

4. The single focal length imaging optical system as claimed in claim 1, satisfying the following condition (3):
L_{M}/Y<3.5 (3)
where
L_{M} is an optical axial distance from an object side surface of the lens element having negative optical power and placed closest to the object side, to an image side surface of the lens element having positive optical power and placed closest to the image side, which lens elements constitute the front unit, and
Y is a maximum image height.

5. The single focal length imaging optical system as claimed in claim 1, satisfying the following condition (4):
−0.60<f/f_{B}<−0.05 (4)
where
f is a focal length of the optical system, and
f_{B} is a focal length of the lens element having negative optical power and placed closest to the image side in the rear unit.

6. The single focal length imaging optical system as claimed in claim 1, satisfying the following condition (5):
0.03<f/f_{A}<0.50 (5)
where
f is a focal length of the optical system, and
f_{A} is a focal length of the lens element having positive optical power and placed closest to the image side in the front unit.

7. The single focal length imaging optical system as claimed in claim 1, satisfying the following condition (6):
1.00<f_{M}/f<3.50 (6)
where
f is a focal length of the optical system, and
f_{M} is a focal length of the front unit.

8. The single focal length imaging optical system as claimed in claim 1, satisfying the following condition (7):
0.25<nd_{MMAX}−nd_{MMIN}<0.60 (7)
where
nd_{MMAX} is a maximum value of a refractive index to a d-line of each lens element constituting the front unit, and
nd_{MMIN} is a minimum value of a refractive index to a d-line of each lens element constituting the front unit.

9. The single focal length imaging optical system as claimed in claim 1, wherein
the lens element having negative optical power and placed closest to the image side in the rear unit is a single lens element.

10. The single focal length imaging optical system as claimed in claim 1, wherein
the lens element having negative optical power and placed closest to the image side in the rear unit is a lens element having a concave surface facing the object side.

11. The single focal length imaging optical system as claimed in claim 1, wherein
the lens element having negative optical power and placed closest to the image side in the rear unit is a meniscus lens element having a concave surface facing the object side.

12. The single focal length imaging optical system as claimed in claim 1, wherein
a lens element placed closest to the object side among the lens elements constituting the focusing lens unit is a lens element having negative optical power and a concave surface facing the object side.

13. A lens barrel configured to hold the single focal length imaging optical system as claimed in claim 1.

14. An interchangeable lens apparatus comprising:
the single focal length imaging optical system as claimed in claim 1; and
a lens mount section which is connectable to a camera body including an image sensor for receiving an optical image formed by the single focal length imaging optical system and converting the optical image into an electric image signal.

15. A camera system comprising:
an interchangeable lens apparatus including the single focal length imaging optical system as claimed in claim 1; and
a camera body which is detachably connected to the interchangeable lens apparatus via a camera mount section, and includes an image sensor for receiving an optical image formed by the single focal length imaging optical system and converting the optical image into an electric image signal.
